(19) United States
(12) Patent Application Publication
(10) Pub. No.: US 2007/0202458 A1
(43) Pub. Date: Aug. 30, 2007

(54) Impression tray for use in dentistry

(76) Inventors: Jose E. Walter, Ranson, WV (US); Thuy-tien Tran Ho, Oakton, VA (US)

Correspondence Address: CASTELLANO PLLC, P.O. Box 1555, Great Falls, VA, 22066, US

(21) Appl. No.: 11/362,538

(22) Filed: Feb. 27, 2006

(51) Int. Cl. A61C 9/00

(52) U.S. Cl. 433/45; 433/41

(57) ABSTRACT

An impression tray has panels supporting the dental impression material. The panels can be removed to allow a post protruding from the jaw to extend through the opening in the tray when the impression is made. The trays provide both flexibility and necessary strength of support.

### FIELD AND BACKGROUND OF THE INVENTION

This invention relates to impression trays for use in dentistry. Using the impressions obtained by the dentist or dental technician, the dental laboratory will make models of teeth for reconstruction or replacement.

When a dentist takes an impression of a patient's teeth or gums he presses a viscous material called “impression material” firmly against the teeth and gums. The material must stay in place until it is partially hardened so that the impression material will provide a sharp and accurate impression from which the laboratory can work in making a model of the portion to be reconstructed. Hence, the trays holding the material must be sufficiently strong to resist being broken when the patient closes his/her mouth on the impression material. After the impression material has hardened sufficiently, the tray with the hardened material is removed from the mouth and the impression is sent to the dental laboratory. Sometimes impressions of only a part of the teeth or jaw are needed. In that case, a tray for a part of the mouth may be sufficient.

It is important that impression trays be easy to use, allowing for some flexibility to adjust to the shape of the mouth. However, such trays must also be strong enough to avoid breakage or displacement when in use and to remain sufficiently rigid during the time the impression is being made. It is, further, advisable that the trays be adaptable to use in situations where a structure would intrude from the gums, such as when a post is placed in the mouth at the position where a tooth is to be implanted (a pick-up impression post). Many prior art trays exist. However, because of expense, easy displacement or breakage or lack of adaptability these prior art devices present many disadvantages.

One prior art impression tray made of stainless steel has segments on which screw or clip into a steel frame work. The removable segments extend over the wall of the container holding the impression material. One or more segments may be removed at the position where the post is located in the mouth, thus making it possible to get the impression with precision as to location and shape of the mouth and teeth around the area in which a new tooth is to be placed. The tray presents a problem in that it is expensive and less flexible than one might wish. Using this prior art tray, an impression of either the upper or lower teeth and jaw may be made.

A second prior art impression tray by TEMREX™, also made of metal, is a dual arch impression tray. (It will take impressions of both the upper and lower jaw simultaneously.) Bridging the walls of the impression tray there is a woven insert against which the impression material is pressed. This impression tray is very rigid and is constructed for repeated use. This tray does not provide segmented portions of the tray to allow selective removal to accommodate a pin.

At tray known as the border-lock tray is a single use impression tray that is provided in eight sizes to accommodate different size mouths. The floor of the tray supporting the impression material is solid and either does not allow for a protrusion of a pin or post when making impression for an implant.

Trays have walls surrounding the floor of the impression trays to retain the impression material. There is always the question of whether rigidity of the tray will allow any desired flexibility and whether the tray providing flexibility will provide the necessary structural integrity to hold the material solidly in place during the taking of the impression.

U.S. Pat. No. 5,890,895 to Tucker discloses a tray having several perforations to allow extrusion of excess impression material.

U.S. Pat. No. 6,428,315 to Prestipino, et al., which is incorporated herein by reference in its entirety, teaches a dental impression tray having segments that can be removed to accommodate a peg. There are multiple creases which allow the tray to break in several places. The tray allows flexibility for use when there is an impression post because of the facility with which segments of the tray can be removed. However, it is not believed to provide the stability found in the instantly claimed invention. The embodiment found in the patent provides means for taking an impression of only the upper or lower jaw.

### SUMMARY OF THE INVENTION

The instant invention provides trays having sufficient rigidity to provide a clean, accurate impression of the teeth and jaw, yet providing enough flexibility of function to allow some adjustment to the size and shape of the jaw and teeth. In one embodiment, an impression of both upper and lower teeth may be taken at one time, thus giving an impression that gives good information relating to occlusal relationships. That embodiment is composed of a base, opposing walls arising therefrom which are a buccal wall and a lingual wall. The tray has a segmented floor wherein opposing segments are attached to the base at either buccal wall side or the lingual wall side. There is a space between opposing segments and adjacent segments to allow desired flexibility.

### BRIEF DESCRIPTION OF THE DRAWINGS

FIG. 1 shows a top planar view of a tray of the invention.

FIG. 2 shows a perspective view of the tray of FIG. 1.

FIG. 3 is a view of the bottom of a tray for taking an impression.

FIG. 4 is a view of the tray of FIG. 3 showing the surface of the tray which holds the impression material.

### DETAILED DESCRIPTION OF THE INVENTION

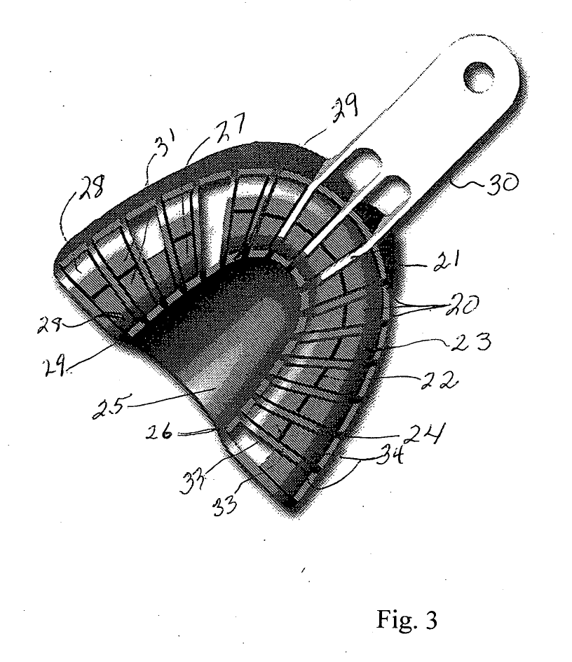

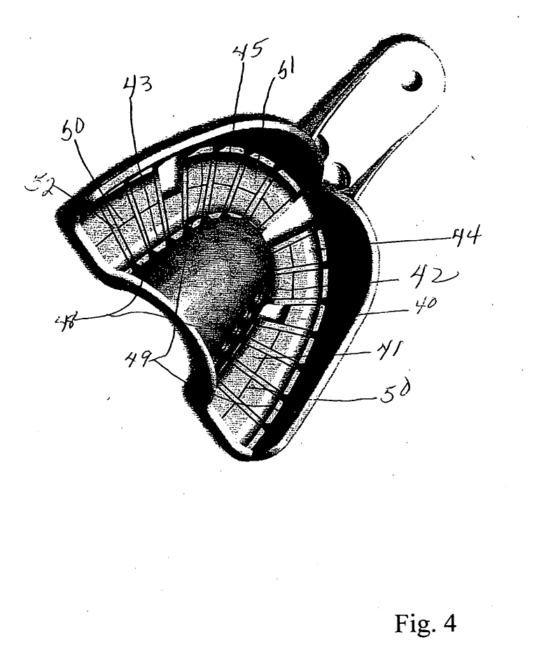

The impression trays of the invention provide both stability and sufficient flexibility for use in making impression trays for use in dentistry. The panels supporting the dental impression material can be removed to allow a post protruding from the jaw to extend through the opening in the tray when the impression is made. In this specification there are times when the term “ridge” and “wall” are used. When using the term “ridge” it is assumed that the rise is less steep than a “wall”. In describing the construct of FIGS. 3 and 4, the terms are used in the alternative, since the shape of that which partially retains the impression material may vary in depth and configuration, a ridge being a less pronounced rise.

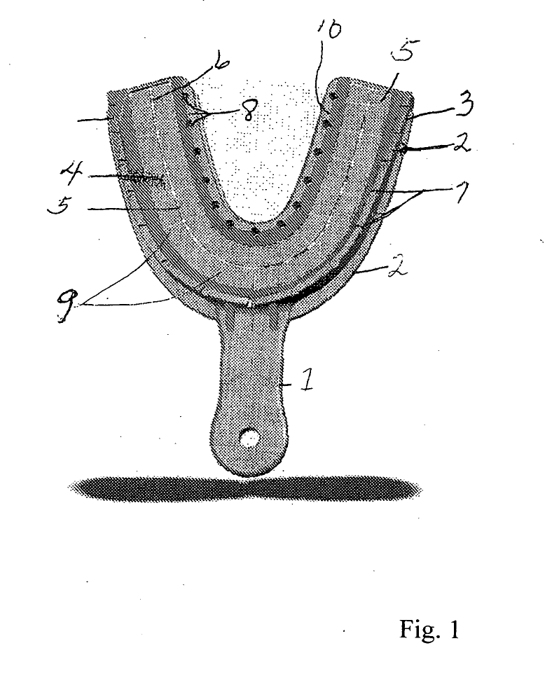

Referring to the drawings, FIG. 1, the impression tray has a base (2) to which is attached a handle (1). Rising from the base is the buccal wall (3) which has attached thereto panels (5) between which there are spaces (6) both between the adjacent panels and the opposing panel (4) extending from the lignual wall (10). The panels attached to the lingual wall are essentially identical to those extending from the buccal wall. One or more of the panels may be removed to allow a post to extend through the panels (5 and 9) which act as the floor upon which the inclusion material rests. The notches (7) at the top of the buccal wall and the lingual wall (8) become filled with impression material to hold the impression material in place.

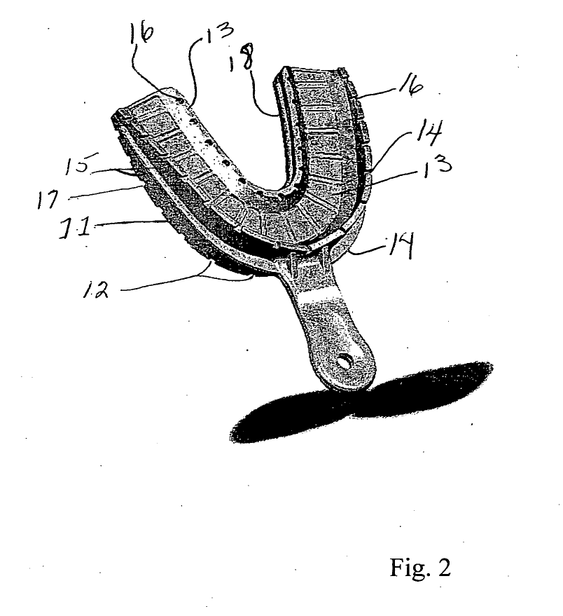

Referring to FIG. 2, it is possible in this figure to observe a buccal wall (15) extending (in the illustration, downward) from the other side of the base (14). The wall has notches (17) and the view upon turning the impression tray will be the same as when viewed as in FIG. 1. The wall extending downward on the lingual side (18) can be seen in this figure as well as the lingual wall (13) with notches (16) as shown in the prior figure.

If an impression of only one jaw is to be made, the tray shown in FIG. 3 may be used. The drawing is a view of the aspect of surface of the tray exposed to the mouth when in use. The impression material would be on the side away from the viewer. The tray consists of a handle (30) which is a part of the tray. The tray has a buccal wall (20) and a lingual wall or ridge (29). In this instance, the handle with the walls forms the foundation for the tray. From the lingual wall extends a panel (22) to form a floor which holds the impression materials. The panels (27, 23) which would support the impression material have a curved portion (28) and a flatter portion (31). The panels may be separated from one another by only spaces or by strips (33) which extend from the lingual wall or ridge to the buccal wall. However, if there are strips separating the panels there are spaces (34) between each strip and adjacent panel so that the panels are readily removed from the tray to allow a post to extend through the tray at the position where the panel has been removed. The lingual ridge is connected throughout by a section (25) which also provides strength and stability.

FIG. 4 shows the tray from the aspect onto which the impression material is placed. The panels (40,41) are seen having curved portions of the panels (42,43) which are breakably attached to the lingual ridge or wall (48) and curved portions (44, 45) which are breakably attached to the buccal wall (49) of the tray. The panels breakably attached to the buccal wall and panels breakably attached to the lingual wall or ridge extend toward each other but either do not meet, leaving a space (50) or have, instead of a complete space, an easily broken attachment between them. The curved portions make it possible, when removing a panel, for a post which extends either toward the inside of the mouth or toward the cheek to extend from the gum through the opening left when the panel is removed. The post may lean either toward the lingual direction (panel 42 ) or in the buccal direction (panel 51). The sides of the panels may be divided by strips or simply by spaces. While strips will provide more support for the over-all structure, a series of spaces separating the panels at their sides will give greater flexibility.

The breakable means attaching panels to the walls or ridges and separating panels from each other, in some instances, can consist of thinner or narrow strips of the materials from which the trays are made or the breakable attachment may arise from perforations at the point of attachment. While various materials used in dental trays, including metals, may be used, it is anticipated that the trays will usually be constructed from plastic which is sufficiently strong to hold its form. Some flexibility of construction material will allow some adjustment to the mouth.

The trays of FIGS. 1 and 2 are useful in that they allow the practitioner to take an impression of both upper and lower teeth at one time. This makes it possible to study bite as it usually occurs in the mouth. However, that tray may also be used when impressions of only upper or lower teeth are to be made. Furthermore, the base may have buccal and lingual walls extending only in one direction from the base for use when making impressions The tray of FIGS. 3 and 4 may be used when impression of only upper or lower teeth and jaw are to be made.

What I claim is:

1. An impression tray having a base, opposing walls which are a buccal wall and a lingual wall, a segmented floor wherein each segment is breakably attached to either said buccal or lingual wall and is independently separable therefrom, each said segment separated from a segment attached to the opposing wall by a space and each said segment separated from the adjacent segment attached to the same wall by a space.

2. The impression tray of claim 1 wherein said buccal wall and said lingual wall extend vertically both upward and downward from said base.

3. The impression tray of claim 1 wherein said buccal and lingual walls extend vertically in only one direction from said base.

4. An impression tray having a buccal wall separated from a lingual ridge or wall, said lingual ridge or wall and buccal wall having extended therefrom separable panels wherein opposing panels, one extending from said lingual ridge or wall and one extending from said buccal wall, are separated from opposing panels by a space, and wherein each said panel is separated from the adjacent panel by a spine having spaces on either side of said spine or the adjacent panels are separated by only a space.

5. The impression tray of claim 4 wherein the panels have a curved portion.

6. The impression tray of claim 4 wherein said panels are curved near the attachment to the lingual wall or ridge and near the attachment to the buccal wall.
